(19) United States
(12) Patent Application Publication
(10) Pub. No.: US 2002/0156221 A1
(43) Pub. Date: Oct. 24, 2002

(54) High solids acrylic resin

(76) Inventors: Gerald Wayne Meyer, Crystal Lake, IL (US); Jean Elizabeth Marie Fletcher, Crystal Lake, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 09/789,128

(22) Filed: Feb. 20, 2001

(51) Int. Cl. C08F 118/02

(52) U.S. Cl. 526/319

(57) ABSTRACT

This invention is directed to monoglycidyl ester modified acrylic polymers. The monoglycidyl ester modified acrylic polymers of the invention are effective for providing polymeric vehicles and formulated coating compositions for coating binders that are high in solids and have reduced levels of volatile organic solvents or volatile organic compounds.

The present invention relates to a high solids acrylic resin composition. More particularly, this invention is directed to polymeric vehicles and formulated coating compositions for coating binders that are high in solids and have reduced levels of volatile organic solvents or volatile organic compounds. The polymeric vehicles of the invention include acrylic polymers or acrylic copolymers formed through the reaction of acrylic monomers or a preformed acrylic polymer with a monoglycidyl compound. The polymeric vehicles of the invention provide a topcoat with properties such as high gloss retention, solvent and humidity resistance, and sufficient hardness and adhesion to be useful in various marine, industrial and maintenance applications.

### BACKGROUND

Marine coatings and other industrial type coatings require certain performance criteria in order for those coatings to be appropriate for those uses. Performance criteria which are often important in these types of applications may include gloss retention, solvent resistance, humidity resistance, salt spray resistance, hardness and adhesion. A coating must provide these types of performance criteria while balancing the need to provide a coating with low amounts of volatile organic compounds and an acceptable viscosity.

The use of high solids polymeric vehicles is one approach that has been used to reduce VOCs in coating compositions. High solids, low volatile organic compound (VOC) containing compositions have become increasingly more important in the coatings industry in part due to government regulations limiting the emissions from those coatings. Further, environmental concern over the use of organic solvents has become increasingly important to the coating industry. This concern not only extends to preservation of the environment for its own sake, but extends to public safety as to both living and working conditions. Volatile organic emissions resulting from coating compositions which are applied and used by industry and by the consuming public are not only often unpleasant, but also contribute to photochemical smog. Governments have established regulations setting forth guidelines relating to volatile organic compounds (VOCs) which may be released to the atmosphere. The U.S. Environmental Protection Agency (EPA) established guidelines limiting the amount of VOCs released to the atmosphere, such guidelines being scheduled for adoption or having been adopted by various states of the United States. Guidelines relating to VOCs, such as those of the EPA, and environmental concerns are particularly pertinent to the paint and coating industry which uses organic solvents that are emitted into the atmosphere.

Typical high solids systems limit the molecular weights of the polymers used in the polymeric vehicle, which limits the impact resistance and other properties of the coating binders and films resulting from the polymeric vehicles. The thermosetting, high solids systems generally obtain higher molecular weight through crosslinking, rather than being obtained from the basic polymer structure. Hence, high solids systems normally supply a large number of reactive sites available for crosslinking such that the resulting compositions have adequate properties. The high functionality tends to increase viscosity and leads to the use of higher levels of organic solvents, and hence VOCs, in order to obtain acceptable viscosities.

U.S. Pat. Nos. 4,818,796 and 4,988,766 describe low molecular weight hydroxyl-containing polymers prepared by reaction of a polymerizable alpha, beta-ethylenically unsaturated carboxylic acid and an epoxy compound. The polymer of the No. '796 patent must have a hydroxyl number of at least 130 and a weight average molecular weight of less than 15,000 such that the polymer is curable with a curing agent to provide desired properties. The hydroxyl containing polymer of the No. '796 patent is prepared by heating an polymerizable alpha, beta-ethylenically unsaturated carboxylic acid and an epoxy compound in the presence of a free radical initiator. The resulting polymer contains an equivalent ratio of acid to epoxy of at least 1 to 1. It does not carefully select and balance a comonomer system, hydroxyl value, polydispersity index and molecular weight to obtain desired properties of cured coating binder which results from curing the modified acrylic polymers of the invention.

### SUMMARY

The invention is directed to monoglycidyl ester modified acrylic polymers. The monomer mix to make the modified acrylic polymers of the invention and the low hydroxyl value of these acrylics provide the modified acrylics of the invention with desirable properties, such as gloss retention, low viscosity, a T_{g} in the range of from about −10° C. to about 60° C. and in an important aspect from about 30° C. to about 50° C., and hardness after polyisocyanate curing of at least about 2B. The lower hydroxyl values of the modified acrylic polymers require lower amounts of crosslinkers such as isocyanate, yet still permit the modified acrylic polymers of the invention to provide an isocyanate cured coating binder with a pencil hardness of at least about 2B and gloss retention of at least about 50% after 1,000 hours of ultra violet light exposure using ASTM test D4587, method B. The use of modifying monoglycidyl ester reactants with selected unsaturated monomers provide a high solids modified acrylic polymer with a low viscosity, low VOC and desirable properties in a resulting coating binder film made with the modified acrylic polymers of the invention.

The acrylic polymers of the invention are a free radically polymerized blend of (1) glycidyl reactive monomers having α, β double bonds which unsaturated monomers are reactive with glycidyl functionality (glycidyl reactive monomer), (2) monomers having α, β double bonds which unsaturated monomers are not reactive with a glycidyl functionality (non-glycidyl reactive comonomer), and (3) hydroxy functional α, β unsaturated monomers which have primary hydroxyl groups. When incorporated into the polymer of the invention, the hydroxyl functionality on the unsaturated monomers will be reactive with isocyanate and aminoplasts. The glycidyl reactive functionality also reacts with a modifying glycidyl reactant having a monoglycidyl group. The modifying glycidyl reactant reacts with the glycidyl reactive functionality on the glycidyl reactive acrylic monomers or free radical polymerization products thereof. The glycidyl reactive acrylic monomers and other unsaturated monomers are free radically polymerized with each other through their respective double bonds. The ratio of acrylic monomer having glycidyl reactive groups to the modifying glycidyl reactant and monomers having hydroxyl groups is effective to provide a monoglycidyl modified acrylic polymer with a hydroxyl value of at least about 80, but less than about 135. In an important aspect, the hydroxyl value is in the range of from about 85 to about 120. The free radical polymerization conditions, free radical initiator and reaction solvent are selected to provide a mono glycidyl modified acrylic polymer with a number average molecular weight of at least about 500 and not more than about 5,000, and in one aspect, from about 1,000 to about 3,000 and a polydispersity index (PDI) of not more than about 3, and generally, from about 2.0 to about 2.4. The low hydroxyl value permits the use of lower amounts of crosslinker, such as a multifunctional isocyanate, to achieve hardness of at least about 2B using not more than about 22 weight HDI trimer isocyanate crosslinker, based upon the weight of the acrylic polymer. The higher molecular-weight, coupled with low PDI of the acrylic polymers of the invention, helps to provide the modified acrylic polymers of the invention with a low viscosity which reduces the need for solvent, and also reduces undesirable VOCs.

The “glycidyl reactive” functionality of the glycidyl reactive acrylic monomer includes carboxyl (—COOH), hydroxyl (—OH) and amine (—NHR, where R═H or a lower alkyl group with one to 4 carbon atoms). Ketones and aldehydes also can be glycidyl reactive. Hence, the monomer having hydroxyl functionality also may serve as the glycidyl reactive acrylic monomer if it is an acrylic monomer. The glycidyl reactive functionality may be an active hydrogen functionality of the glycidyl reactive acrylic monomer. This functionality may be hydroxyl, but not all acrylic monomers with active hydrogen functionality can be or serve as the hydroxyl functional α, β ethylenically unsaturated monomers.

Generally, the modifying glycidyl reactant will be from about 15 to about 40 weight percent of the weight of all of the reactants used to make the modified acrylic polymer which are monomers 1 through 3 and the modifying glycidyl reactant. The glycidyl reactive acrylic monomer having glycidyl reactive functionality generally will comprise from about 1 to about 20 weight percent of comonomers 1 through 3 and the modifying glycidyl reactant, the non glycidyl reactive comonomer will comprise from about 40 to about 80 weight percent of comonomers 1 through 3 and the modifying glycidyl reactant, the hydroxy functional comonomers having primary —OH will comprise from about 3 to about 25 weight percent of comonomers 1 through 3 and the modifying glycidyl reactant

The modifying glycidyl reactant is a glycidyl ester, and in one aspect, the glycidyl reactive functionality on the acrylic monomer is a carboxylic acid group which is reactive with the epoxy ring on the glycidyl ester. In a very important aspect, the modifying glycidyl esters are glycidyl esters of versatic acid. The glycidyl reactive monomers having glycidyl reactive functionality should in total be in at least an equal molar amount of the glycidyl ester. If the glycidyl reactive functionality of the glycidyl reactive monomer is a primary hydroxy, then the primary hydroxy functional monomer and glycidyl reactive monomer should be in sufficient molar excess over the molar amount of glycidyl ester to provide the resulting polymer with an hydroxyl value of from about 80 to about 135.

The α, β ethylenically unsaturated monomers which do not have a glycidyl reactive functional group (the non-glycidyl reactive comonomer) include styrene, alpha-methylstyrene, vinyl acetate (VA), vinyl toluene, and acrylic or methacrylic esters, such as methyl (meth)acrylate, ethyl (meth)acrylate, isopropyl (meth)acrylate, n-butyl (meth)acrylate, isobutyl (meth)acrylate, n-amyl (meth)acrylate, isoamyl (meth)acrylate, n-hexyl (meth)acrylate, 2-ethylhexyl (meth)acrylate, n-octyl (meth)acrylate, allyl methacrylate, methyl methacrylate (MMA), butyl acrylate (BA), butyl methacrylate (BMA), ethyl acrylate (EA), and lauryl methacrylate.

The non-glycidyl reactive comonomer should not be in excess of 80 weight percent, based on the total weights of the above reactants 1 through 3 and the modifying glycidyl reactant used to make the modified acrylic polymer.

The modified acrylic polymers of the invention have a solids content of at least about 70 weight percent, preferably 80 weight percent, and a viscosity of not more than about 6,800 cps at 25° C. at 80 weight percent solids and not more than 20 weight percent organic solvent. The modified acrylic polymers of the invention are effective for providing polymeric vehicles with such solids content and viscosities and formulated coating compositions with VOC levels of less than about 250 grams per liter.

The modified acrylic polymers and polymeric vehicles of the invention are effective for providing coating binders having a high gloss retention, at least 50% after 1,000 hours of UV light exposure under ASTM test D4587 method B, a hardness of at least about 2B, and an adhesion of at least about 4B over cold rolled steel.

Generally, the modifying monoglycidyl reactant comprises from about 15 to about 40 weight percent of the weight of the above reactants 1 through 3 and modifying monoglycidyl reactant used to make the modified acrylic polymer. The modifying monoglycidyl reactant also generally has a molecular weight in the range of from about 130 to about 500, and as previously noted are glycidyl esters. Particularly useful glycidyl esters used in the invention have the general formula

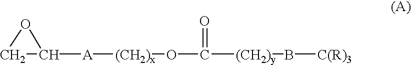

where

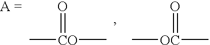

or bond

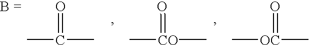

or bond, R represents H, the same or a mixture of primary, secondary or tertiary aliphatic groups having from about 1 to about 26 carbon atoms and x is from 1 to 20, and y=0 to 20. The glycidyl esters of versatic acid are commercially under the trademarks Glydexx® and Cardura® from ExxonMobil Chemical Company and Resolution Performance Products, respectively.

In one aspect of the invention, the glycidyl reactive acrylic monomers and the other comonomers and monoglycidyl compound are pre-reacted with the modifying glycidyl reactant prior to free radical initiated polymerization of the acrylic double bonds. To catalyze the reaction, the reaction mixture may include a catalyst such as ethyl triphenyl phosphonium iodide (ETPPI) at a temperature of about 100° C. to about 120° C., or stannous octate at about 100° C. to about 120° C. Also, the monoglycidyl modifying reactant can be reacted with a preformed acrylic copolymer.

In yet another aspect of the invention, glycidyl reactive acrylic monomers and/or comonomers and monoglycidyl compound may be reacted together where the glycidyl reactant reacts with the glycidyl reactive functionality and the free radical polymerization occurs at the same time in a “one pot” reaction. In all aspects of the invention, the monoglycidyl modifying reactant is not polymerized into the “backbone” of the acrylic polymer or copolymer, but rather reacts with the glycidyl reactive functionality which extends from the carbons which form the length of the polymer. Because the modifying glycidyl reactant is a glycidyl ester, that reactant will provide a moiety on the modified acrylic polymer with a moiety of the monoglycidyl ester such as

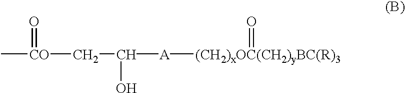

wherein A, B, x and y are defined above and R is H, the same or a mixture of primary, secondary or tertiary aliphatic groups containing 1 to 26 carbon atoms which may include one or more ester linkages.

In an important aspect the moiety of the monoglycidyl ester has the formula

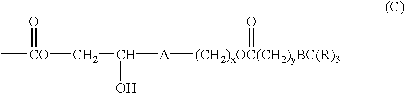

where

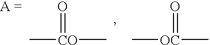

or bond

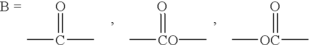

or bond, R represents H, or the same or a mixture of aliphatic groups having from about 1 to about 26 carbon atoms and x is from 1 to 20, and y=0 to 20. In an important aspect, the modifying glycidyl reactant are the glycidyl esters of versatic acid which means a compound of the above formula where A and B are bond, x=1, y=0 and R is alkyl and one of the three R groups is CH₃ and the remaining two R groups have a total of from about 9 to about 11 carbons. By so modifying the carboxyl functionality of the acrylic polymer, the glycidyl reactant changes the topology of the acrylic copolymer.

### DETAILED DESCRIPTION

Definitions

“Polymeric vehicle” means all polymeric and resinous components in the formulated coating, i.e., before film formation. The polymeric vehicle may include a cross-linking agent.

“Coating binder” means the polymeric part of the film of the coating after solvent has evaporated and after any potential crosslinking has occurred.

“Formulated coating” means the polymeric vehicle and solvents, pigments, catalysts and additives which may optionally be added to impart desirable application characteristics to the formulated coating and desirable properties such as opacity and color to the film.

“Cross-linker” means a di- or polyfunctional substance, such as an isocyanate or aminoplasts, all of which have functional groups which are capable of forming covalent bonds with the acrylic polymer such as through the hydroxyl functionality, carboxyl functionality and/or other active hydrogen functionality.

“Solvent” means an organic solvent.

“Organic solvent” means a liquid which includes but is not limited to carbon and hydrogen where the liquid has a boiling point in the range of not more than about 280° C. at about one atmosphere pressure.

“Glycidyl reactive functionality” means carboxyl, ketone, aldehyde, hydroxyl and/or amine functionality which is reactive with a glycidyl functionality.

As used herein “acrylic monomer” means a monomer such as

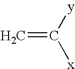

wherein

y=methyl, ethyl, propyl, butyl or H

x=—COOR₁, or —NR₂R₃ where R₁=H or lower alkyl

R₂=H or lower alkyl, R₃=H or lower alkyl, but at least one of R₂ or R₃ is H.

A glycidyl reactive acrylic monomer means an acrylic monomer as defined herein which also includes a glycidyl reactive moiety if it does not already have it by virtue of x being glycidyl reactive.

The Monoglycidyl Modifying Reactant.

As discussed, the modifying monoglycidyl ester reactants will generally have the structure:

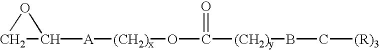

wherein A, B, x and y are defined above and R is H, the same or a mixture of a primary, secondary or tertiary aliphatic group containing 1 to 26 carbon atoms which may include one or more ester linkages.

The modified acrylic polymers of the invention are a free radically polymerized blend of (1) glycidyl reactive acrylic monomers having a glycidyl reactive functionality, (2) monomers having α, β double bonds which unsaturated monomers are not reactive with a glycidyl functionality (non-glycidyl reactive comonomer), and (3) hydroxy functional α, β unsaturated monomers which have primary hydroxyl groups. The polymer made with these monomers is modified with the monoglycidyl ester. This modification can take place before polymerization with the glycidyl reactive monomers, during the free radical polymerization in a “one pot” process, or after the free radical polymerization. The free radical polymerization conditions, the modifying glycidyl reactant, and ratio of monomers are effective for providing a monoglycidyl modified acrylic polymer with a hydroxyl value of from about 80 to less than about 135, a T_{g} of from about 30° C. to about 5° C., a number average molecular weight of at least about 500 and not more than about 5,000, and in one aspect, from about 1,000 to about 3,000 and a polydispersity index (PDI) of not more than about 3, and in one aspect, from about 2.0 to about 2.4. Generally, the modifying glycidyl ester reactant will be from about 15 to about 40 weight percent of the weight of reactants 1 through 3 and the weight of the modifying glycidyl ester used to make the modified acrylic polymer. The glycidyl reactive acrylic monomer having glycidyl reactive functionality should in total be in at least an equal molar amount of the modifying glycidyl ester reactant as described above.

If the glycidyl reactive functionality is a hydroxyl group, a standard esterification catalyst is needed to help that reaction. These catalysts include octoates such as staneous octoate, BF₃ used at about 30° C., acid clay catalyst used at about 100° C., aliphatic amine used at about room temperature to about 110° C., aromatic amine at about 160° C., and aldehydes and ketones used at about 25° C. with BF₃.

The polymerization solvent, initiator and the polymerization reaction temperature are all carefully selected to provide the molecular weight range and PDI for the modified acrylic polymers of the invention. Solvents such as ethyl 3-ethoxypropionate (EEP), xylene, di-isobutyl carbinol, ketones such as methyl amyl ketone, esters such as hexyl and heptyl acetate, and glycol ethers and glycol esters such as propylene glycol monoethyl ether acetate and isobutyl isobutyrate may be used. Free radical initiators such as di-t-amyl peroxide (DTAP), non-aromatic initiators, di-tertiary butyl or amyl peroxide may be used. In an important aspect, carboxyl groups are particularly useful for the active hydrogens which will react with the modifying glycidyl ester reactant. To control PDI and molecular weight, higher reaction temperatures help keep PDI desirably low and the same higher temperatures are needed to get the glycidyl reactant to react with carboxyl active hydrogen group. Useful reaction temperatures are from about 120° C. to about 200° C.

Schematic Representations Of The Reactions To Obtain The Modified Acrylic Polymers.

In one aspect of the invention, acrylic monomers and/or comonomers and monoglycidyl compound are pre-esterified prior to free radical initiated polymerization. An example of the pre-esterification reaction is as follows.

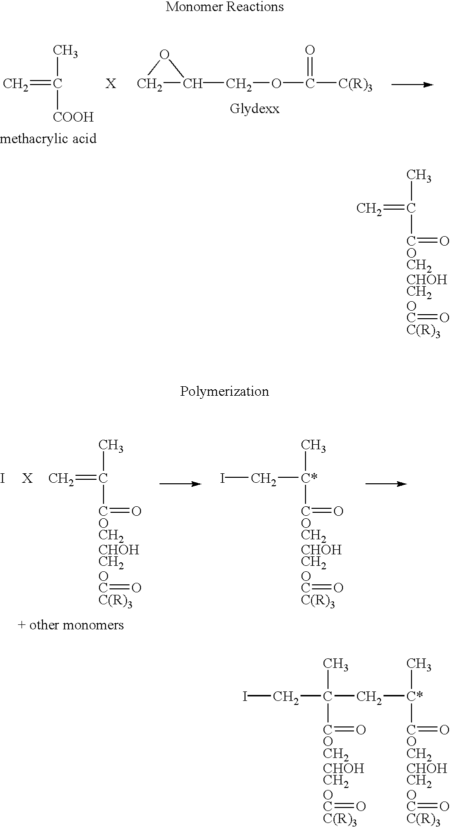

Alternatively, a monoglycidyl compound can be reacted with a preformed acrylic polymer or copolymer.

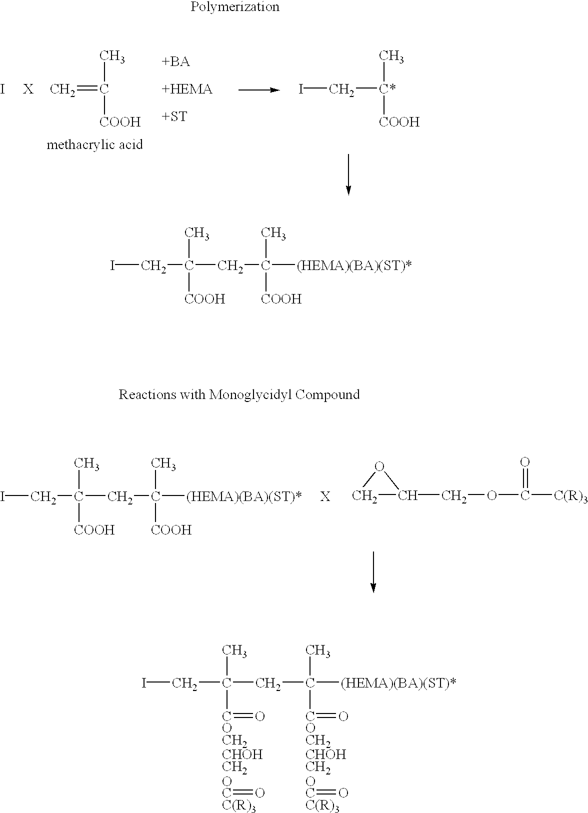

Reactions with Isocyanates

In another aspect of the invention, the hydroxyl functionality of the unsaturated monomers will be reactive with isocyanate. Useful isocyanates may include diisocyanates and polyisocyanates.

Diisocyanates which may be used in the invention include hexamethlenediisocyanate (HDI) and isophorone diisocyanate (IPDI). The polyisocyanates may be dimerized or trimerized diisocyanates such as trimerized HDI or IPDI.

In another aspect of the invention, unblocked or biurets such as the biuret of hexamethylene diisocyanate (HDI) which biuret has the structure

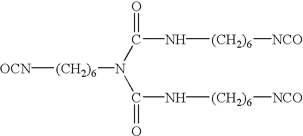

and is a trimerized product of hexamethylene diisocyanate and water may be used in lieu of polyisocyanates.

The following examples illustrate methods for carrying out the invention and should be understood to be illustrative of, but not limiting upon, the scope of the invention which is defined in the appended claims.

### EXAMPLES

### EXAMPLE I

Modification Procedures and Resin Synthesis

i. Resin Preparation

814.1 g. of EEP and 309.9 g. of Cardura E-10 are charged to a 3L 4-neck round bottom flask equipped with a thermocouple controlled heating mantle, an overhead stirrer, nitrogen sparge and a condenser. The reactor contents are heated to 162.8° C. (325° F.). All acrylic and styrene monomers in Table 1 are premixed along with 16.4 g. EEP and 25.00 g. DTAP in a separate container. Once the EEP solvent had stabilized at approximately 163° C., the monomer/initiator mixture are pumped into the flask over a 6 hour period (approximately 2.70 g/min). After the addition is complete, the mix container is washed with 9.40 g. EEP and added to the reactor. After 1 hour continued stirring at 163° C., Gardner viscosity, color, resin solids and acid value (AV) are recorded. An additional 2.5 g. DTAP is then washed into the reactor with 4.70 g. EEP. After 1 hour continued stirring at 163° C., Gardner viscosity, color, resin solids and AV are again recorded. The resin is allowed to react for a total of 8 hours.

Following this reaction period, the reactor contents are cooled to 154° C. The reaction flask is modifed to include a short-path vacuum distillation head with a thermometer in-line with the condenser and a receiver flask. Stirring is stopped and vacuum is slowly applied to avoid bumping and resin foaming. Full vacuum (28 inches of mercury) is eventually achieved. Stirring is resumed and distillation is allowed to proceed until temperatures stabilized at 154° C. and essentially no futher solvent is collected. A minimum of 97% resin solids is needed before distillation is halted.

The resin is allowed to cool to a minimum of 140° C. at which point the n-butyl acetate is introduced into the reactor. The resin solution is allowed to cool to 110° C. Final resin solution is allowed to cool to 110° C. Final resin solids (80+1.0%), viscosity, color and AV are recorded.

TABLE 1

| | % in Total | % Incorporated |
|---|---|---|
| Raw Material | Formulation | into Resin |
| Cardura ® E-10 | 13.2-16.1 | about 22.5-about 27.5 |
| Methacrylic Acid | 5.2-6.4 | about 9.0-about 11.0 |
| Hydroxyethyl Methacrylate | 5.5-6.7 | about 9.3-about 11.4 |
| Butyl Acrylate | 10.8-13.2 | about 18.4-about 22.5 |
| Styrene | 12.7-15.6 | about 21.7-about 26.5 |
| Butyl Methacrylate | 5.3-6.5 | about 9.1-about 11.1 |
| Ethyl 3-Ethoxypropionate | 36.0-44.0 | |
| Di-t-Amyl Peroxide | 1.2-1.4 | |

2-Component Paint Formula

The paint formula used to screen and test the acrylic resins is found in the following:

| Raw Materials | Amount (g) |
|---|---|
| Part A | |
| Resin | 100.0 |
| DisperBYK ® 110 | 7.21 |
| Ti-Pure ® R-902 | 367.5 |
| n-butyl acetate | 65.0 |
| Grind to 7 Hegman | |
| Resin | 357.7 |
| T-12 Catalyst | 0.16 |
| Disparlon ® OX-70 | 7.8 |
| BYK ® 306 | 1.1 |
| n-butyl acetate | 17.0 |
| Part B | |
| Desmodur ® N-3300 | 90.9 |

Paint Testing Procedures

The following Table lists the tests performed to evaluate each 2-component urethane paint and an ASTM reference where available.

| Test Performed | Method or ASTM Reference |
|---|---|
| Adhesion | D 3359 |
| Pencil Hardness | D 3363 |
| UV Resistance | D 4587 Method B |
| Salt Spray | B 117 |
| Humidity Resistance | D 4587 |
| Leveling | D 2801 |
| Sag | D 4400 |
| Viscosity | Stormer Viscometer— |
| | Part A only |
| Potlife | 2X Initial Viscosity— |
| | Brookfield |
| Chemical Resistance | 24 hour Spot Test |
| Conical Mandrel Bend | D 522 |
| Dry Time | Circular Dry Time— |
| | D5895 |

Paint Properties.

| | 25% Cardura E-10 |
|---|---|
| Adhesion (CRS) | 5B |
| Adhesion (E-coat) | 5B |
| Pencil Hardness | B |
| Leveling (5-best) | 4.5 |
| Sag (12-best) | 8.5 |
| Viscosity (Part A) (KU) | 83 |
| Potlife (hrs) | 2.0 |
| Dry Time (hrs) | |
| Set to Touch | 1.5 |
| Surface Dry | 2.5 |
| Through Dry | 4.75 |
| Print Free | >6.0 |
| Humidity (500 hrs) | 9D |
| Salt Spray (500 hrs) | |
| Scribe Creep | 2 mm |
| Field Blisters | 3MD |
| Field Appearance | 3RS |
| Wet Adhesion | 100% fail |
| OUV-A340 (60°/20°) | |
| Initial | 100.8/90.6 |
| 475 hours | 82.3/73.3 |
| 1508 hours | 82.1/53.7 |
| 1995 hours | 79.4/46.7 |
| 3803 hours | 20.2/2.0 |

Numerous modifications and variations in practice of the invention are expected to occur to those skilled in the art upon consideration of the foregoing detailed description of the invention. Consequently, such modifications and variations are intended to be included within the scope of the following claims.

What is claimed is:

1. A glycidyl modified acrylic polymer which is the reaction product of reactants comprising:
at least one acrylic monomer having a glycidyl reactive functional group;
at least one nonglycidyl reactive monomer having an α, β double bond which unsaturated monomer is not reactive with a glycidyl functionality;
at least one hydroxy functional α, β unsaturated monomer which has a hydroxyl group; and
at least one modifying glycidyl ester reactant, the acrylic monomer having the glycidyl reactive functionality which is reactive with the glycidyl functionality of the modifying glycidyl reactant, the acrylic monomer, the nonglycidyl reactive monomer and hydroxy functional unsaturated monomer being polymerized through their double bonds to provide the glycidyl modified acrylic polymer, the glycidyl modified acrylic polymer having a hydroxyl number of not more than about 135, a polydispersity index of not more than about 3, and a Mn in the range of from about 500 to about 5,000.

2. The glycidyl modified acrylic polymer as recited in claim 1 wherein the acrylic monomer having glycidyl reactive functionality is at least an equal molar amount of the modifying glycidyl ester reactant.

3. The glycidyl modified acrylic polymer as recited in claim 1, wherein the modifying glycidyl ester reactant comprises from about 15 to about 40 weight percent based upon the weights of the glycidyl acrylic monomer, nonglycidyl reactive monomer, hydroxyl functional α, β unsaturated monomer and modifying glycidyl ester reactant.

4. The glycidyl modified acrylic polymer as recited in claims 1, 2 or 3 wherein the nonglycidyl reactive monomer is selected from the group consisting of styrene, vinyl acetate, alpha-methylstyrene, vinyl toluene, methyl (meth)acrylate, ethyl (meth)acrylate, isopropyl (meth)acrylate, n-butyl (meth)acrylate, isobutyl (meth)acrylate, n-amyl (meth)acrylate, isoamyl (meth)acrylate, n-hexyl (meth)acrylate, 2-ethylhexyl (meth)acrylate, n-octyl (meth)acrylate, allyl methacrylate, methyl methacrylate, butyl acrylate, butyl methacrylate, ethyl acrylate, lauryl methacrylate, and mixture thereof.

5. The glycidyl modified acrylic polymer as recited in claims 1, 2 or 3, wherein the polymerization reaction is initiated by initiators selected from the group consisting of di-tertiary amyl peroxide, non-aromatic initiators, di-tertiary butyl peroxide, amyl peroxide and mixtures thereof.

6. The glycidyl modified acrylic polymer as recited in claims 1 or 2, wherein the modifying glycidyl ester reactant has the formula 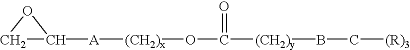
wherein A is 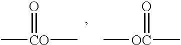
or bond, B is 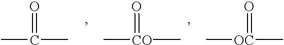
R is H, the same or a mixture of a primary, secondary or tertiary aliphatic group containing 1 to 26 carbon atoms which may include one or more ester linkages, x is from 1 to 20 and y is from 0 to 20.

7. The glycidyl modified acrylic polymer as recited in claim 6, wherein the glycidyl reactive functional group of the acrylic monomer is selected from the group consisting of carboxyl, hydroxyl, amine and mixtures thereof.

8. A glycidyl modified acrylic polymer as recited in claim 7 wherein the modified acrylic polymer has a solids content of at least about 80%, an organic solvent content of less than 20 weight percent and a viscosity of not more than about 6,800 cps at about 25° C.

9. A glycidyl modified acrylic polymer which is the reaction product of reactants comprising:
at least one acrylic monomer having a glycidyl reactive functional group selected from the group consisting of carboxyl, hydroxyl and amino;
at least one nonglycidyl reactive monomer having an α, β double bond which unsaturated monomer is not reactive with a glycidyl functionality;
at least one hydroxy functional α, β unsaturated monomer which has a hydroxyl group; and
at least one modifying glycidyl ester reactant which has the general formula 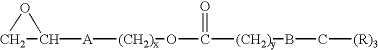
wherein A is 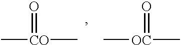
or bond, B is 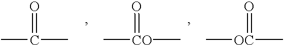
R is H, the same or a mixture of a primary, secondary or tertiary aliphatic group containing 1 to 26 carbon atoms which may include one or more ester linkages, x is from 1 to 20 and y is from 0 to 20,
the acrylic monomer having a glycidyl reactive functionality which is reactive with the glycidyl functionality of the modifying glycidyl reactant, the nonglycidyl reactive monomer and hydroxy functional unsaturated monomer being polymerized through their double bonds to provide the glycidyl modified acrylic polymer, the glycidyl modified acrylic polymer having a hydroxyl number of not more than about 135, a T_{g} of from about 30° C. to about 5° C., a polydispersity index of not more than about 3, a Mn in the range of from about 500 to about 5,000, a solids content of at least about 80%, an organic solvent content of less than 20 weight percent and a viscosity of not more than about 6,800 cps at about 25° C.

10. The glycidyl modified acrylic polymer as recited in claim 9 wherein the acrylic monomer having glycidyl reactive functionality is at least an equal molar amount of the modifying glycidyl ester reactant.

11. The glycidyl modified acrylic polymer as recited in claim 10 wherein the nonglycidyl reactive monomer is selected from the group consisting of styrene, vinyl acetate, alpha-methylstyrene, vinyl toluene, methyl (meth)acrylate, ethyl (meth)acrylate, isopropyl (meth)acrylate, n-butyl (meth)acrylate, isobutyl (meth)acrylate, n-amyl (meth)acrylate, isoamyl (meth)acrylate, n-hexyl (meth)acrylate, 2-ethylhexyl (meth)acrylate, n-octyl (meth)acrylate, allyl methacrylate, methyl methacrylate, butyl acrylate, butyl methacrylate, ethyl acrylate, lauryl methacrylate, and mixture thereof.

12. A glycidyl modified acrylic polymer comprising:
an acrylic polymer modified with at least about 15 weight percent of a monoglycidyl moiety, based on the weight of the modified acrylic polymer, the monoglycidyl moiety having the formula 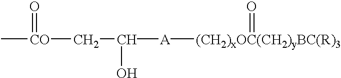
wherein A is 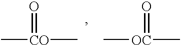
or bond, B is 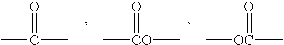
R₃ H, the same or a mixture of a primary, secondary or tertiary aliphatic group containing 1 to 26 carbon atoms which may include one or more ester linkages, x is from 1 to 20 and y is from 0 to 20,
wherein the glycidyl modified acrylic polymer has a hydroxyl number of not more than about 135 to about 80, a number average molecular weight of from about 500 to about 5,000, a polydispersity index of not more than about 3, a T_{g} of from about 30° C. to about 5° C., a solids content of at least about 80%, an organic solvent content of less than 20 weight percent and a viscosity of not more than about 6,800 cps at about 25° C.

13. The glycidyl modified acrylic polymer as recited in claim 11 wherein the acrylic polymer is a reaction product of a glycidyl reactive acrylic monomer, at least one nonglycidyl reactive monomer having an α, β double bond which unsaturated monomer is not reactive with a glycidyl functionality; and at least one hydroxy functional α, β unsaturated monomer which has a hydroxyl group.

14. A glycidyl modified acrylic polymer comprising:
an acrylic polymer modified with at least about 15 weight percent of a monoglycidyl residue, based on the weight of the modified acrylic polymer, the monoglycidyl residue having the formula 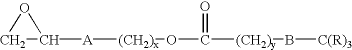
where A is 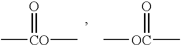
or bond, B is 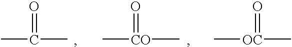
or bond, R represents H, the same or a mixture of aliphatic groups having from about 1 to about 26 carbon atoms and x is from 1 to 20, and y is 0 to 20,
wherein the glycidyl modified acrylic polymer has a hydroxyl number of not more than about 135 to about 80, a number average molecular weight of from about 500 to about 5,000, a polydispersity index of not more than about 3, a T_{g} of from about 30° C. to about 5° C., such that when the glycidyl modified acrylic polymer has a solids content of at least about 80% and an organic solvent content of less than 20 weight percent, the glycidyl modified acrylic has a viscosity of not more than about 6,800 cps at about 25° C.

15. A glycidyl modified acrylic polymer which is the reaction product of reactants comprising:
at least one acrylic monomer having a glycidyl reactive functional group selected from the group consisting of carboxyl, hydroxyl and amino;
at least one nonglycidyl reactive monomer having an α, β double bond which unsaturated monomer is not reactive with a glycidyl functionality;
at least one hydroxy functional α, β unsaturated monomer which has a hydroxyl group; and
at least one modifying glycidyl ester reactant which has the general formula 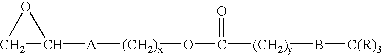
where A is 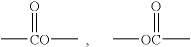
or bond, B is 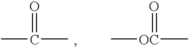
or bond R represents the same or a mixture of aliphatic groups having from about 1 to about 26 carbon atoms and x is from 1 to 20, and y is 0 to 20,
the acrylic monomer having a glycidyl reactive functionality which is reactive with the glycidyl functionality of the modifying glycidyl reactant, the nonglycidyl reactive monomer and hydroxy functional unsaturated monomer being polymerized through their double bonds to provide the glycidyl modified acrylic polymer, the glycidyl modified acrylic polymer having a hydroxyl number of not more than about 135, a T_{g} of from about 30° C. to about 50° C., a polydispersity index of not more than about 3, a Mn in the range of from about 500 to about 5,000, a solids content of at least about 80%, an organic solvent content of less than 20 weight percent and a viscosity of not more than about 6,800 cps at about 25° C.

16. A method for making a glycidyl modified acrylic polymer comprising reacting
at least one acrylic monomer having a glycidyl reactive functional group;
at least one nonglycidyl reactive monomer having an α, β double bond which unsaturated monomer is not reactive with a glycidyl functionality;
at least one hydroxy functional α, β unsaturated monomer which has a hydroxyl group; and
at least one modifying monoglycidyl ester reactant, the acrylic monomer having the glycidyl reactive hydrogen functionality which is reactive with the glycidyl functionality of the modifying glycidyl reactant, the nonglycidyl reactive monomer and hydroxy functional unsaturated monomer being polymerized through their double bonds to provide the glycidyl modified acrylic polymer, the glycidyl modified acrylic polymer having a hydroxyl number of not more than about 135, a polydispersity index of not more than about 3, and an Mn in the range of from about 500 to about 5,000.

17. A glycidyl modified acrylic polymer which is the reaction product of reactants comprising:
from about 9.0 to about 11.0 weight percent methacrylic acid;
from about 9.3 to about 11.4 weight percent hydroxyethyl methacrlate;
from about 18.4 to about 22.5 weight percent butyl acrylate;
from about 21.7 to about 26.5 weight perent styrene; from about 9.1 to about 11.1 weight percent butyl methacrylate; and
from about 22.5 to about 27.5 weight percent of at least one modifying glycidyl ester reactant which has the general formula 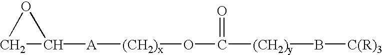
where A is 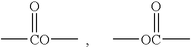
or bond, B is 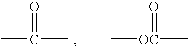
or bond, R represents the same or a mixture of aliphatic groups having from about 1 to about 26 carbon atoms and x is from 1 to 20, and y is 0 to 20,
the glycidyl modified acrylic polymer having a hydroxyl number of not more than about 120, a T_{g} of from about 30° C. to about 5° C., a polydispersity index of about 2.0 to about 2.4, a Mn in the range of from about 500 to about 3,000, a solids content of at least about 80%, an organic solvent content of less than 20 weight percent and a viscosity of not more than about 6,800 cps at about 25° C.

18. A glycidyl modified acrylic polymer according to claim 17, wherein the modifying glycidyl ester reactant has the formula [chemical structure]
